(19) United States
(12) Patent Application Publication
(10) Pub. No.: US 2009/0067092 A1
(43) Pub. Date: Mar. 12, 2009

(54) Magnetic recording medium, magnetic recording and reproducing apparatus, and method for manufacturing magnetic recording medium

(75) Inventors: Takahiro Suwa, Tokyo (JP); Kazuya Shimakawa, Tokyo (JP)

Correspondence Address: OLIFF & BERRIDGE, PLC, P.O. BOX 320850, ALEXANDRIA, VA, 22320-4850, US

(73) Assignee: TDK CORPORATION, TOKYO (JP)

(21) Appl. No.: 12/230,680

(22) Filed: Sep. 3, 2008

(30) Foreign Application Priority Data
Sep. 10, 2007 (JP) 2007-234300

(51) Int. Cl. G11B 5/82; B44C 1/22

(52) U.S. Cl. 360/135; 216/22; 428/831.2; G9B/5.293

(57) ABSTRACT

The magnetic recording medium includes: a recording layer formed over a substrate in a predetermined concavo-convex pattern, convex portions of the concavo-convex pattern constituting recording elements; a filler underlayer film formed on the bottoms of concave portions of the concavo-convex pattern; and a DLC filler formed on the filler underlayer film in contact with the filler underlayer film so as to fill the concave portions. The filler underlayer film is made of a material selected from the group consisting of a Si-containing material, a Ge-containing material, and a carbide material containing one or more metal elements selected from Ti, Ta, Nb, Mo, Zr, Cr, W, V, and Hf.

### BACKGROUND OF THE INVENTION

1. Field of the Invention

The present invention relates to a magnetic recording medium having a recording layer formed in a concavo-convex pattern, such as a discrete track medium and a patterned medium, a magnetic recording and reproducing apparatus having the same, and a method for manufacturing a magnetic recording medium.

2. Description of the Related Art

A significant improvement in the areal density of conventional magnetic recording media such as hard disks has been achieved by, for example, reducing the size of magnetic particles constituting a recording layer, changing materials, and improving the precision of head processing. Further improvements in areal density are also expected in the future. The improvements in areal density by means of conventional improvement techniques are approaching their limit, however, due to the advent of problems such as processing limits with respect to the magnetic heads, erroneous recording of information on tracks adjoining a target track due to the spread of the recording field, and crosstalk during reproduction.

Discrete track media and patterned media have been proposed as candidates for magnetic recording media that are capable of providing a further improvement in areal density. In these media, a recording layer is formed in a concavo-convex pattern so that the convex portions of the concavo-convex pattern constitute recording elements. For hard disks and other magnetic recording media, the surface flatness is a significant factor for stabilizing the head flying height to provide favorable recording and reproducing characteristics. It is therefore preferable to fill the concave portions between the recording elements with a filler, and remove any excess of a filler lying above the recording layer to flatten the surfaces of the recording elements and the filler. The filler is preferably made of diamond-like carbon (DLC) which is nonmagnetic and has high hardness (for example, see Japanese Patent Application Laid-Open No. 2003-109210). It should be noted that DLC is also used as a material for the protective film of a magnetic recording layer. DLC can be deposited using chemical vapor deposition (CVD) or other techniques. In order to remove any excess filler and thereby provide surface flattening, techniques such as chemical mechanical polishing (CMP) and dry etching can be used (for example, see Japanese Patent Application Laid-Open No. 2000-195042).

However, the DLC filler has a problem with respect to reliability as it exfoliates easily, despite the advantage of having high hardness. It is important to note that the protective film is not affected by this exfoliation problem even though DLC is also used as a material for the protective film, as mentioned above. The protective film is in the order of several nanometers thick, and the filler that fills the concave portions between the recording elements is thicker than this protective film. For this reason, the DLC filler is considered to be prone to exfoliation.

### SUMMARY OF THE INVENTION

In view of the foregoing problems, various exemplary embodiments of this invention provide a magnetic recording medium of high reliability having a recording layer formed in a concavo-convex pattern in which concave portions are filled with a DLC filler that is resistant to exfoliation, a magnetic recording and reproducing apparatus having the same, and a method for manufacturing a magnetic recording medium like this.

The foregoing object of the present invention has been achieved by the provision of a magnetic recording medium including: a recording layer formed over a substrate in a predetermined concavo-convex pattern, a convex portion of the concavo-convex pattern constituting a recording element; a filler underlayer film formed on a bottom of a concave portion of the concavo-convex pattern; and a DLC filler formed on the filler underlayer film in contact with the filler underlayer film so as to fill the concave portion. The filler underlayer film is made of a material selected from the group consisting of a Si-containing material, a Ge-containing material, and a carbide material containing one or more metal elements selected from Ti, Ta, Nb, Mo, Zr, Cr, W, V, and Hf.

The foregoing object of the present invention has also been achieved by the provision of a method of manufacturing a magnetic recording medium, including: a filler underlayer film deposition step of depositing a filler underlayer film on at least a bottom of a concave portion and an upper surface of a convex portion of a predetermined concavo-convex pattern on an object to be processed, the object to be processed having a substrate and a recording layer formed over the substrate in the concavo-convex pattern, the convex portion of the concavo-convex pattern constituting a recording element; a filler deposition step of depositing a DLC filler over the object to be processed so as to be in contact with the filler underlayer film, thereby filling the concave portion of the concavo-convex pattern with the filler; and a flattening step of etching an excess of the filler above the recording element to flatten the surface thereof. The filler underlayer film is made of a material selected from the group consisting of a Si-containing material, a Ge-containing material, and a carbide material containing one or more metal elements selected from Ti, Ta, Nb, Mo, Zr, Cr, W, V, and Hf.

DLC has the property of firmly adhering to the materials selected from the group consisting of a Si-containing material, a Ge-containing material, and a carbide material containing one or more metal elements selected from Ti, Ta, Nb, Mo, Zr, Cr, W, V, and Hf. Since the filler underlayer film made of a Si-containing material or the like is formed on at least the bottom of the concave portion, and the filler is formed in contact with the filler underlayer film, it is possible to provide a magnetic recording medium of high reliability in which the DLC filler that fills the concave portion is resistant to exfoliation.

Accordingly, various exemplary embodiments of this invention provide a magnetic recording medium comprising: a substrate; a recording layer formed over the substrate in a predetermined concavo-convex pattern, a convex portion of the concavo-convex pattern constituting a recording element; a filler underlayer film formed on a bottom of a concave portion of the concavo-convex pattern; and a DLC filler formed on the filler underlayer film in contact with the filler underlayer film so as to fill the concave portion, the filler underlayer film being made of a material selected from the group consisting of a Si-containing material, a Ge-containing material, and a carbide material containing one or more metal elements selected from Ti, Ta, Nb, Mo, Zr, Cr, W, V, and Hf.

Moreover, various exemplary embodiments of this invention provide a method for manufacturing a magnetic recording medium, comprising: a filler underlayer film deposition step of depositing a filler underlayer film on at least a bottom of a concave portion and an upper surface of a convex portion of a predetermined concavo-convex pattern on an object to be processed, the object to be processed having a substrate and a recording layer formed over the substrate in the concavo-convex pattern, the convex portion of the concavo-convex pattern constituting a recording element; a filler deposition step of depositing a DLC filler over the object to be processed so as to be in contact with the filler underlayer film, thereby filling the concave portion of the concavo-convex pattern with the filler; and a flattening step of etching an excess of the filler above the recording element to flatten the surface, the filler underlayer film being made of a material selected from the group consisting of a Si-containing material, a Ge-containing material, and a carbide material containing one or more metal elements selected from Ti, Ta, Nb, Mo, Zr, Cr, W, V, and Hf.

In the description of the present application, the phrase “a recording layer formed in a concavo-convex pattern” does not only refer to a recording layer that is formed by dividing a continuous recording layer into a predetermined pattern so that the convex portions for constituting recording elements are completely separated from each other, but shall also cover the following: a recording layer that has mutually separated convex portions in data areas, which are continuous near borders between the data areas and servo areas; a recording layer that is continuously formed over a part of the substrate, such as one having a spiral configuration; a recording layer that is formed separately on the upper surfaces of convex portions and the bottoms of concave portions of an concavo-convex patterned underlayer film so that the portions formed on the upper surfaces of the convex portions constitute recording elements; a recording layer that is continuous at the bottom, having concave portions halfway in the thickness direction; and a recording layer of continuous film which is deposited in a concavo-convex pattern following a concavo-convex patterned underlayer film.

In the description of the present application, the term “DLC” is used to refer to a material that is mainly composed of carbon, with SP³ hybrid orbitals of carbon bonds. The “material that is mainly composed of carbon” is used to refer to one that contains carbon atoms as many as or more than 50% in number with respect to the total number of atoms constituting the material.

Moreover, in the description of the present application, the term “magnetic recording media” is not limited to media, such as hard disks, floppy (registered trademark) disks, and magnetic tapes in which magnetism alone is used to record and reproduce magnetic signals. This term is also used to refer to magneto-optical recording media, such as MO disks, in which both magnetism and light are used and to heat assisted type recording media in which both magnetism and heat are used.

According to the present invention, it is possible to achieve a magnetic recording medium of high reliability having a recording layer formed in a concavo-convex pattern in which concave portions are filled with a DLC filler that is resistant to exfoliation, a magnetic recording and reproducing apparatus having the same, and a method for manufacturing a magnetic recording medium like this.

### BRIEF DESCRIPTION OF THE DRAWINGS

FIG. 1 is a perspective view schematically showing the general structure of main components of a magnetic recording and reproducing apparatus according to a first exemplary embodiment of the present invention;

FIG. 2 is a cross-sectional view schematically showing the structure of a magnetic recording medium of the magnetic recording and reproducing apparatus;

FIG. 3 is an enlarged cross-sectional view schematically showing the structure near the recording layer of the magnetic recording medium;

FIG. 4 is a flowchart showing the outline of the manufacturing process of the magnetic recording medium;

FIG. 5 is a cross-sectional view schematically showing a structure of a starting body of an object to be processed in the manufacturing process of the magnetic recording medium;

FIG. 6 is a cross-sectional view schematically showing a shape of the object to be processed in which a resin layer has been formed in a concavo-convex pattern;

FIG. 7 is a cross-sectional view schematically showing a shape of the object to be processed in which the recording layer has been processed in a concavo-convex pattern;

FIG. 8 is a cross-sectional view schematically showing a shape of the object to be processed in which a separating film has been deposited over the recording layer;

FIG. 9 is a cross-sectional view schematically showing a shape of the object to be processed in which a filler underlayer film is deposited over the separating film;

FIG. 10 is a cross-sectional view schematically showing a shape of the object to be processed in which a filler has been deposited on the filler underlayer film;

FIG. 11 is a cross-sectional view schematically showing a shape of the object to be processed in which the filler underlayer film over recording elements has been exposed in a former flattening step;

FIG. 12 is a cross-sectional view schematically showing a shape of the object to be processed in which entire surface has been flattened in a latter flattening step;

FIG. 13 is an enlarged cross-sectional view schematically showing the structure near the recording layer of the magnetic recording medium according to a second exemplary embodiment of the present invention;

FIG. 14 is an enlarged cross-sectional view schematically showing the structure near the recording layer of the magnetic recording medium according to a third exemplary embodiment of the present invention;

FIG. 15 is a flowchart showing the outline of the manufacturing process of the magnetic recording medium according to a forth exemplary embodiment of the present invention;

FIG. 16 is a photograph showing the surface of the object to be processed after removal of an adhesive tape from the surface in working example 1;

FIG. 17 is a photograph showing the surface of the object to be processed immediately after the filler deposition step in comparative example 1; and

FIG. 18 is a photograph showing the surface of the object to be processed after removal of an adhesive tape from the surface in comparative example 2.

### DETAILED DESCRIPTION OF THE PREFERRED EMBODIMENTS

Hereinafter, preferred exemplary embodiments of the present invention will be described in detail with reference to the drawings.

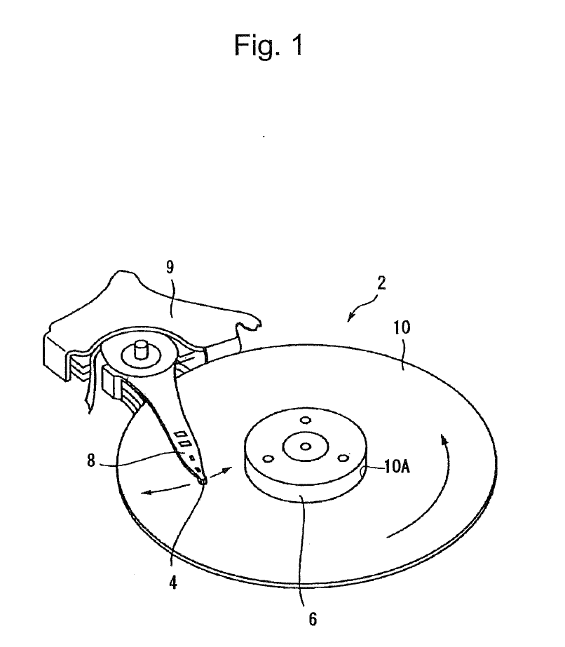

As shown in FIG. 1, a magnetic recording and reproducing apparatus 2 according to a first exemplary embodiment of the present invention includes a magnetic recording medium 10 and a magnetic head 4. The magnetic head 4 is intended to record and reproduce a magnetic signal on/from the magnetic recording medium 10, and is arranged so as to be flyable in close proximity to the surface of the magnetic recording medium 10.

The magnetic recording medium 10 has a center hole 10A. The magnetic recording medium 10 is secured at the center hole 10A to a chuck 6 so as to be rotatable with the chuck 6. The magnetic head 4 is mounted near the end of an arm 8. The arm 8 is rotatably attached to a base 9. As a result, the magnetic head 4 can move in close proximity to the surface of the magnetic recording medium 10, in an arc-shaped trajectory along a radial direction of the magnetic recording medium 10.

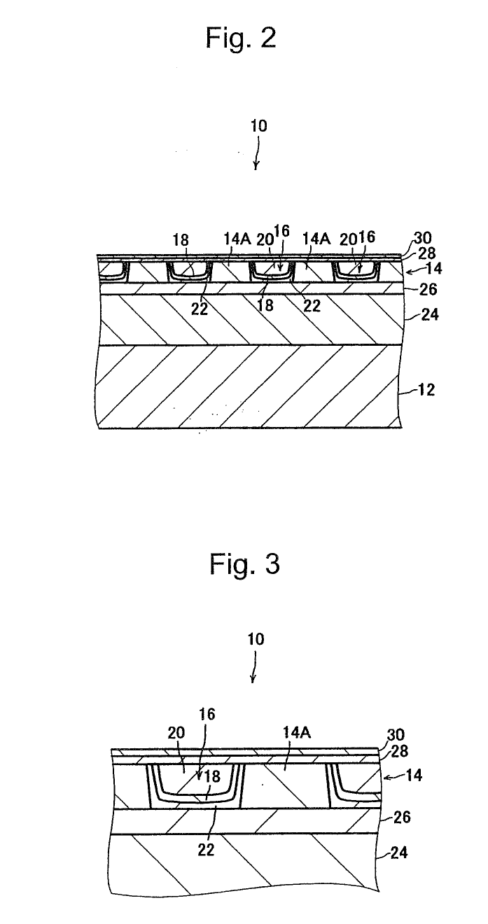

The magnetic recording medium 10 is a discrete track medium of perpendicular recording type. As shown in FIGS. 2 and 3, the magnetic recording medium 10 has a recording layer 14, a filler underlayer film 18, and a DLC filler 20. The recording layer 14 is formed over a substrate 12 in a predetermined concavo-convex pattern so that convex portions of the concavo-convex pattern constitute recording elements 14A. The filler underlayer film 18 is formed on the bottoms of concave portions 16 of the concavo-convex pattern. The filler 20 is formed on the filler underlayer film 18 in contact with the filler underlayer film 18 so as to fill the concave portions 16. The filler underlayer film 18 is made of a material selected from the group consisting of a Si-containing material, a Ge-containing material, and a carbide material containing one or more metal elements selected from Ti, Ta, Nb, Mo, Zr, Cr, W, V, and Hf. The filler underlayer film 18 is also formed on the sides of the concave portions 16 (or the sides of the recording elements 14A). The filler 20 is also in contact with the filler underlayer film 18 on the sides of the concave portions 16. The magnetic recording medium 10 further includes a separating film 22 which is formed between the recording layer 14 and the filler underlayer film 18 so as to separate these from each other. The separating film 22 contains neither Si nor Ge. The magnetic recording medium 10 is characterized by these filler underlayer film 18, filler 20, and separating film 22. The rest of the configuration does not seem to be particularly important in understanding the first exemplary embodiment. A description thereof will thus be omitted where appropriate.

The magnetic recording medium 10 includes a soft magnetic layer 24, a seed layer 26, the recording layer 14, a protective layer 28, and a lubricating layer 30, which are formed over the substrate 12 in that order.

The substrate 12 has a generally disk-like shape with a center hole. The substrate 12 may be made of glass, Al, Al₂O₃, or the like.

The recording layer 14 has a thickness of 5 to 30 nm. The recording layer 14 may be made of materials such as a CoCrPt alloy and other CoCr alloys, FePt alloys, stacked bodies of these, and a material having a matrix of SiO₂ or other oxide materials and CoPt or other ferromagnetic particles contained in the matrix. The recording elements 14A, the convex portions of the recording layer 14, are in contact with the upper surface of the protective layer 28. In data areas, the recording elements 14A are formed so that they are radially separated into a large number of concentric arcs at small intervals, which are shown in FIGS. 2 and 3. In servo areas, the recording elements 14A are formed as separated in a predetermined servo pattern (not shown).

The filler underlayer film 18 has a thickness of 0.1 to 6 nm. Specific examples of the material forming the filler underlayer film 18 include Si, Si oxides such as SiO₂, Si carbides such as SiC, Si nitrides such as Si₃N₄, and other Si-containing materials such as TaSi. The filler underlayer film 18 may also be made of Ge-containing materials such as Ge or Ge compounds. The filler underlayer film 18 may also be made of carbides that contain one or more metal elements selected from Ti, Ta, Na, Mo, Zr, Cr, W, V, and Hf.

The filler 20 is made of DLC as mentioned above. Examples of DLC include tetrahedral amorphous carbon which contains no hydrogen, amorphous carbon which contains hydrogen, a mixture of these, and ones that partly or locally have a polyethylene- or polyacetylene-like structure.

The separating film 22 has a thickness of 1 to 10 nm. The separating film 22 may be made of a material that contains neither Si nor Ge. Examples include nonmagnetic metals such as Ta, Ti, Mn, Nb, Mo, Zr, Cr, W, Al, Cu, V, and Hf, alloys containing these, and oxides and nitrides of these. Like the filler underlayer film 18, the separating film 22 is also formed on the bottoms of the concave portions 16 and the sides of the same (or the sides of the recording elements 14A), thereby separating the filler underlayer film 18 and the recording elements 14A from each other.

The soft magnetic layer 24 has a thickness of 50 to 300 nm. The soft magnetic layer 24 may be made of such materials as Fe alloys and Co alloys.

The seed layer 26 has a thickness of 2 to 40 nm. The seed layer 26 may be made of such materials as nonmagnetic CoCr alloys, Ti, Ru, a Ru—Ta laminate, and MgO.

The protective layer 28 has a thickness of 1 to 5 nm. The protective layer 28 may be made of DLC. The protective layer 28 and the filler 20 may be made of the same type or different types of DLCs. For example, the DLCs may have SP³ hybrid orbitals of carbon bonds in different ratios.

The lubricating layer 30 has a thickness of 1 to 2 nm. The protective layer 30 may be made of perfluoropolyether (PFPE).

Next, the operation of the optical recording medium 10 will be described.

The DLC has the property of firmly adhering to materials selected from the group consisting of a Si-containing material, a Ge-containing material, and a carbide material containing one or more metal elements selected from Ti, Ta, Nb, Mo, Zr, Cr, W, V, and Hf. The magnetic recording medium 10 has the filler underlayer film 18 formed on the bottoms of the concave portions 16, and this filler underlayer film 18 is made of a material selected from the group consisting of a Si-containing material, a Ge-containing material, and a carbide material containing one or more metal elements selected from Ti, Ta, Nb, Mo, Zr, Cr, W, V, and Hf. Since the DLC filler 20 is formed in contact with the filler underlayer film 18, the filler 20 is less likely to exfoliate and thus has high reliability.

Furthermore, the filler underlayer film 18 is formed not only on the bottoms of the concave portions 16 but also on the sides of the concave portions 16, with the filler 20 also in contact with the filler underlayer film 18 on the sides of the concave portions 16. The DLC filler 20 is thus firmly attached to the filler underlayer film 18 even at the sides of the concave portions 16. This produces a further improvement in reliability.

Si and Ge have a high chemical reactivity with Co. Suppose that the filler underlayer film 18 contains Si or Ge and the recording layer 14 contains Co. In this case, the Si or Ge in the filler underlayer film 18 and the Co in the recording layer 14 may chemically combine with each other to change the magnetic characteristics of the recording layer 14 if the filler underlayer film 18 is in contact with the recording layer 14. Nevertheless, the magnetic recording medium 10 has the separating film 22 which separates the recording layer 14 and the filler underlayer film 18 from each other, containing neither Si nor Ge. This prevents or suppresses the combination between the Si or Ge contained in the filler underlayer film 18 and the Co contained in the recording layer 14, thereby preventing or suppressing a change in the magnetic characteristics of the recording layer 14. Also in this respect, the magnetic recording medium 10 is improved in reliability.

The upper surfaces of the recording elements 14A, being the convex portions of the recording layer 14, are in contact with the protective layer 28, without the filler underlayer film 18 or the separating film 22 lying on the recording elements 14A. The magnetic gap between the recording elements 14A and the magnetic head 4 is thus not increased because of the filler underlayer film 18 or the separating film 22. This provides the magnetic recording and reproducing apparatus 2 with favorable recording and reproduction characteristics.

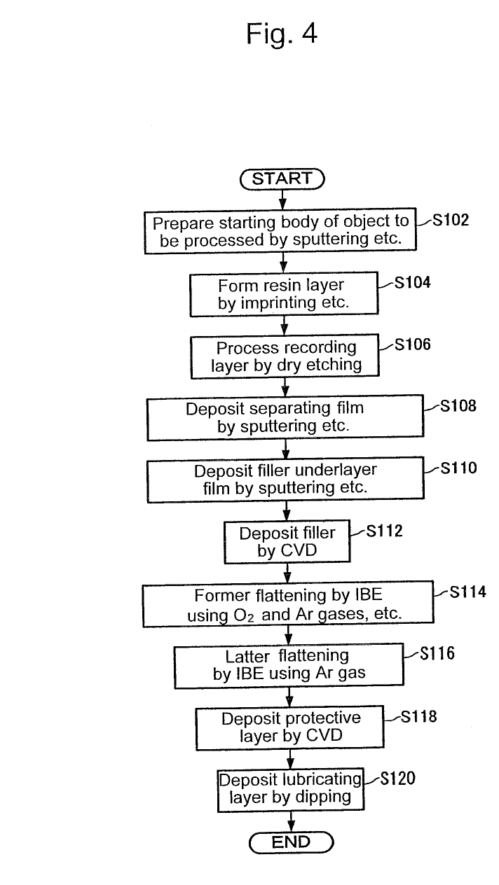

Next, a method for manufacturing the magnetic recording medium 10 will be described with reference to the flowchart shown in FIG. 4.

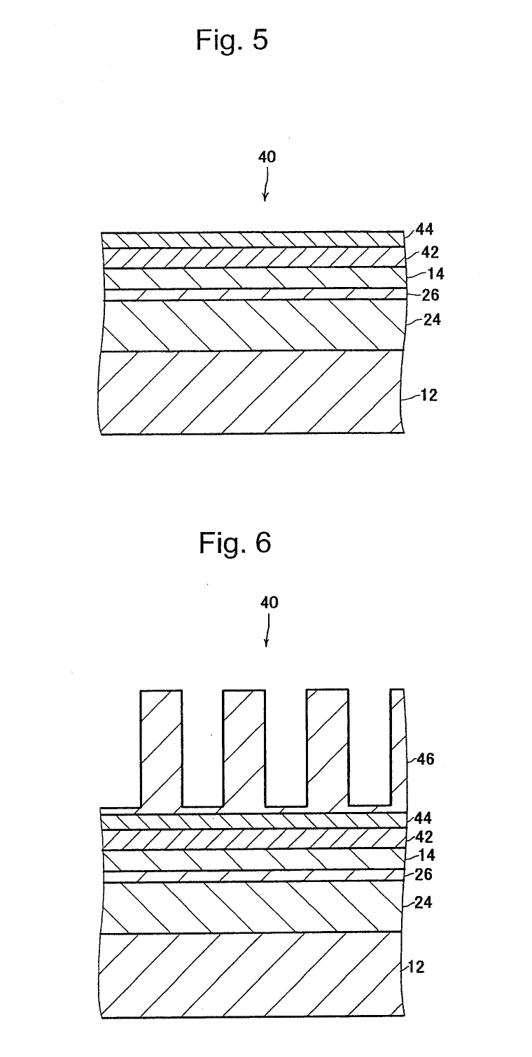

Initially, the starting body of an object to be processed 40 is prepared as shown in FIG. 5 (S102). The starting body of the object to be processed 40 is obtained by depositing the soft magnetic layer 24, the seed layer 26, a recording layer 14 (a continuous layer before processed to the concavo-convex pattern), a first mask layer 42, and a second mask layer 44 in this order over the substrate 12 by sputtering or the like.

The first mask layer 42 is made of TiN or the like with a thickness of 3 to 50 nm. The second mask layer 44 is made of Ni or the like with a thickness of 3 to 30 nm.

Next, as shown in FIG. 6, a resin material is applied onto the second mask layer 44 of the object to be processed 40 by spin coating or the like. Using a not-shown stamper, a concavo-convex pattern corresponding to that of the recording layer 14 is transferred to the resin material by imprinting, whereby a resin layer 46 is formed in the concavo-convex pattern (S104). Examples of the imprinting techniques available include optical imprinting using ultraviolet rays or the like, and thermal imprinting. For optical imprinting, the resin layer 46 may be made of materials such as an ultraviolet curable resin. For thermal imprinting, the resin layer 46 may be made of materials such as a thermoplastic resin. The resin layer 46 has a thickness (height of the convex portion) of 30 to 300 nm, for example. Alternatively, a photosensitive resist or an electron beam resist may be used as the resin material. Optical lithography or electron-beam lithography techniques can be used to form the resin layer 46 in the concavo-convex pattern corresponding to that of the recording layer 14.

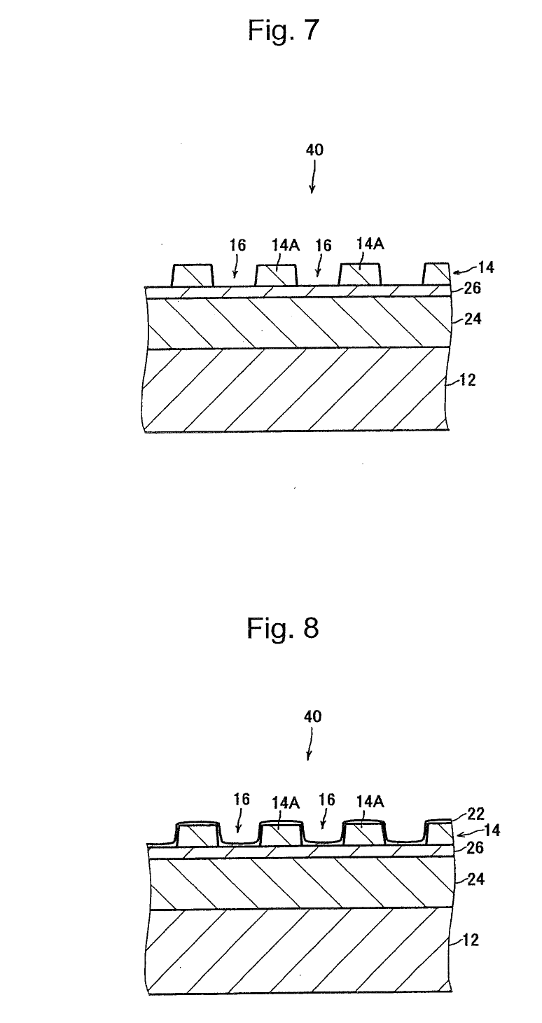

Next, the resin layer 46 is removed from the bottoms of the concave portions by ashing, if necessary, before the second mask layer 44 is removed from the bottoms of the concave portions by ion beam etching using Ar gas. The first mask layer 42 is further removed from the bottoms of the concave portions by reactive ion etching using SF₆ (sulfur hexafluoride). The recording layer 14 is then removed from the bottoms of the concave portions by reactive ion etching, using CO gas and NH₃ gas as the reactive gases (S106). This forms the foregoing recording layer 14 in the concavo-convex pattern, divided in a large number of recording elements 14A as shown in FIG. 7. Note that the first mask layer 42 may sometimes be left on the upper surfaces of the recording elements 14A. The first mask layer 42 remaining on the recording elements 14A is then removed completely by reactive ion etching using SF₆ gas as the reactive gas. A reducing gas such as NH₃ gas is supplied to remove the SF₆ gas and the like from the surface of the object to be processed 40.

Next, as shown in FIG. 8, the separating film 22 is deposited over the object to be processed 40 having the recording layer 14 formed in the concavo-convex pattern, by sputtering or other techniques (S108). The separating film 22 is formed in a concavo-convex pattern following the concavo-convex pattern of the recording layer 14. Consequently, the separating film 22 is formed on the bottoms and sides of the concave portions 16. Note that the separating film 22 is also formed over the recording elements 14A.

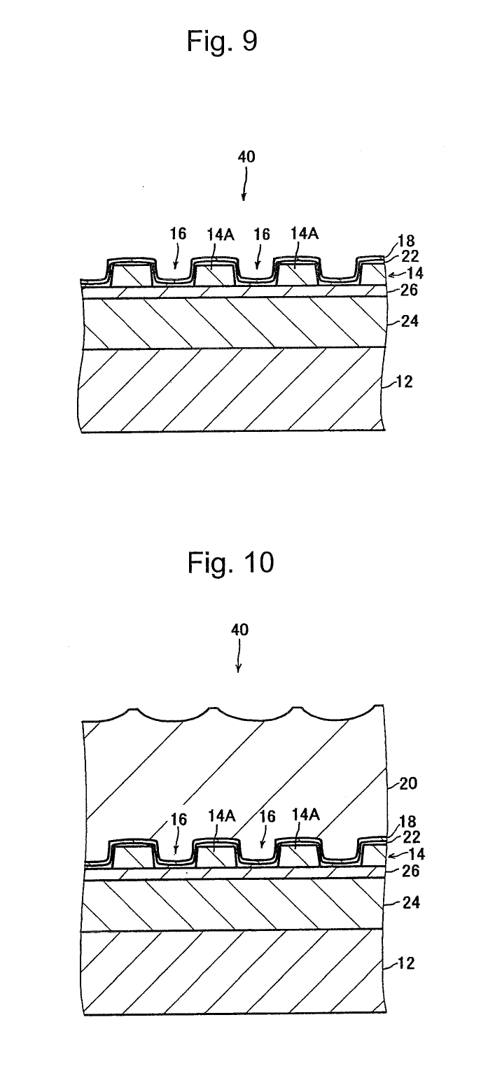

Next, as shown in FIG. 9, the filler underlayer film 18 is deposited over the separating film 22 by sputtering or other techniques (S110). The filler underlayer film 18 is also formed in a concavo-convex pattern following the concavo-convex pattern of the recording layer 14. Here, the separating film 22 separates the recording layer 14 from the filler underlayer film 18 while the filler underlayer film 18 is deposited. The filler underlayer film 18 is also formed on the bottoms and sides of the concave portions 16. The filler underlayer film 18 is also formed over the recording elements 14A (over the upper surfaces of the convex portions).

Next, as shown in FIG. 10, the DLC filler 20 is deposited over the object to be processed 40 by CVD or the like so as to be in contact with the filler underlayer film 18, whereby the concave portions 16 are filled with the filler 20 (S112). Now, if the filler 20 deposited has a large difference in level between the concave portions and the convex portions, it is sometimes impossible to flatten the surface sufficiently even by removing an excess of the filler 20. The filler 20 deposited on the recording layer 14 with the concavo-convex pattern has a tendency that the difference in level between the surfaces of the concave portions and the convex portions gradually decreases with increasing thickness. In reality, the difference in level between the concave portions and the convex portions at the surface is less easy to decrease, however, since the filler 20 is made of DLC. In order to suppress the difference in level between the concave portions and the convex portions at the surface of the filler 20, the filler 20 is preferably deposited in a large thickness. The deposition thickness of the filler 20 is preferably 50 to 300 nm, and more preferably 200 to 300 nm. It should be noted that FIG. 10 shows the concavo-convex shape as more exaggerated than the actual shape for the sake of better understanding of the first exemplary embodiment. Now, depositing the DLC filler 20 in such a large thickness may hinder the adhesion of the filler 20 to the surface of the object to be processed 40, sometimes failing to deposit the filler 20 on the surface of the object to be processed 40 in part or even at all. DLC has the property of firmly adhering to materials selected from the group consisting of a Si-containing material, a Ge-containing material, and a carbide material containing one or more metal elements selected from Ti, Ta, Nb, Mo, Zr, Cr, W, V, and Hf. Since the filler 20 is formed in contact with the filler underlayer film 18 which is made of such materials, it is possible to deposit the filler 20 on the entire surface of the object to be processed 40 without fail. The filler 20 is also resistant to exfoliation after the deposition. The CVD material gas may be methane, ethylene, toluene, etc. The use of methane is preferred since it is highly effective in reducing the difference in level between the concave portions and the convex portions at the surfaces with increasing thickness.

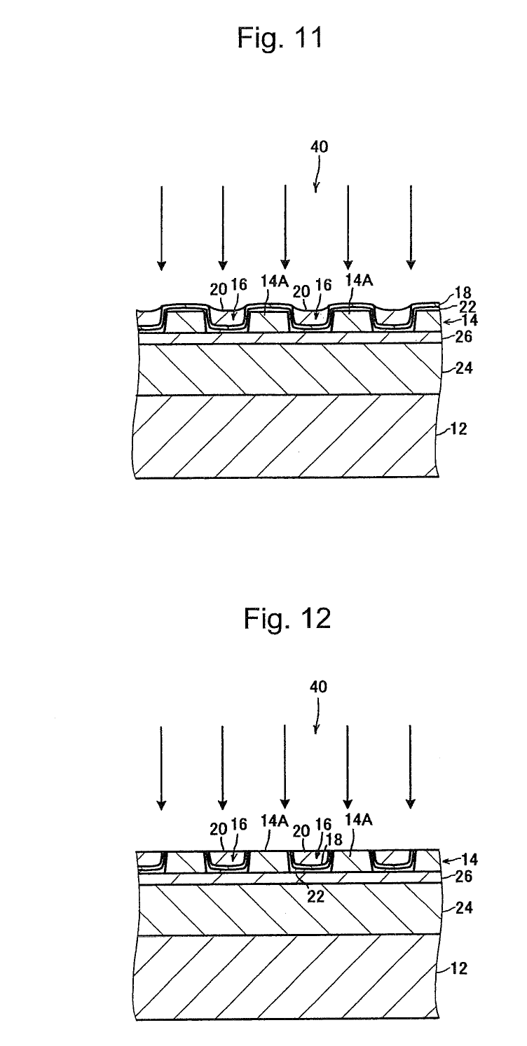

Next, the surface of the object to be processed 40 is flattened in two steps. Specifically, ion beam etching (IBE) or reactive ion etching (RIE) is initially performed, whereby the surface of the object to be processed 40 is irradiated with a mixed process gas of O₂ gas and Ar gas. As shown in FIG. 11, an excess of the filler 20 above the recording elements 14A is thus etched off (S114). Here, the phrase “an excess of the filler 20” is used to refer to the portion of the filler 20 lying above the recording elements 14A, above the upper surface of the recording layer 14 (opposite from the substrate 12). The angle of incidence of the process gas is set to, for example, 90°, perpendicular to the surface. The arrows in FIG. 11 schematically show the direction of incidence of the process gas.

In this step, the etching conditions are preferably set so that the etching rate to the filler 20 is higher than that to the filler underlayer film 18 and the separating film 22. While the DLC filler 20 has a high hardness, the chemical reaction with O₂ gas makes it brittle for increased etching rate. On the other hand, Ta and other metal materials, as well as Si, make no increase in brittleness even when exposed to the O₂ gas. The etching rates thereto are thus lower than that to the DLC. The foregoing etching conditions are satisfied, for example, when the filler underlayer film 18 is made of Si and the separating film 22 is made of Ta.

In this step, the etching is preferably stopped based on the result of detection of components contained in the filler underlayer film 18 that is removed with the filler 20. The etching may also be stopped based on the result of detection of components contained in the separating film 22. For example, the etching is stopped immediately after it is detected by secondary-ion mass spectrometry (SIMS) or quadrupole mass spectrometry (QMS) that the amount of detection of components contained in the filler underlayer film 18 or the separating film 22 reaches a local maximum value. Immediately after the filler underlayer film 18 or the separating film 22 starts being scattered, there is only a small amount of components of the filler underlayer film 18 or the separating film 22 scattered. Therefore, it is sometimes difficult for SIMS or QMS to make a clear distinction between data and noise, the data indicating that the components contained in the filler underlayer film 18 or the separating film 22 start being detected. This sometimes makes it difficult to clearly detect when the etching reaches the filler underlayer film 18 or the separating film 22. In contrast, it is relatively easy to determine if the amount of detection of components contained in the filler underlayer film 18 or the separating film 22 reaches a local maximum value, or to determine if the components contained in the filler underlayer film 18 or the separating film 22 have substantially disappeared. Consequently, the etching is stopped with some delay after the filler underlayer film 18 or the separating film 22 over the recording elements 14A is exposed from the filler 20. Since the etching rate to the filler 20 is set to be higher than those to the filler underlayer film 18 and/or the separating film 22, the upper surface of the filler 20 over the concave portions 16 is several nanometers lower than the upper surface of the filler substrate 18 or the separating film 22 over the recording elements 14A when the etching is stopped. Note that the etching may be stopped when the components contained in the filler underlayer film 18 or the separating film 22 start being detected, if it is possible to clearly detect the start of detection of the components contained in the filler underlayer film 18 or the separating film 22 immediately after the filler underlayer film 18 or the separating film 22 starts being scattered.

Next, the surface of the object to be processed 40 is irradiated with a process gas of Ar by IBE, thereby removing an excess of the filler underlayer film 18 and the separating film 22 over the recording element 14A. As shown in FIG. 12, this flattens the upper surfaces of the recording elements 14A and the upper surfaces of the filler 20 in the concave portions 16 (S116). Like the phrase “an excess of the filler 20,” the phrase “an excess of the filler underlayer film 18 and the separating film 22” is used to refer to the portions of the filler underlayer film 18 and the separating film 22 that lie above the recording elements 14A. Even in this step, the angle of incidence of the process gas is set to, for example, 90°, perpendicular to the surface. The arrows in FIG. 12 schematically show the direction of incidence of the process gas. In this step, an RIE apparatus may be used for the Ar gas irradiation.

The etching conditions in this step are preferably set so that the etching rates to the filler underlayer film 18 and the separating film 22 are higher than that to the filler 20. Causing no chemical reaction, Ar gas typically shows only a small difference in the etching rate depending on the materials. The DLC (filler 20) has a high hardness, and thus the IBE using the Ar gas has a lower etching rate thereto than those to the other materials. Therefore, the foregoing etching conditions are satisfied.

Since the etching rates to the filler underlayer film 18 and the separating film 22 are set to be higher than that to the filler 20, the filler underlayer film 18 and the separating film 22 over the recording elements 14A are etched faster than the filler 20 in the concave portions 16. This reduces the difference in level between the concave portions and the convex portions. The etching is stopped when the filler underlayer film 18 and the separating film 22 over the recording elements 14A are removed. As a result, the upper surfaces of the recording elements 14A and the upper surfaces of the filler 20 in the concave portions 16 become almost identical in height (in position in the thickness direction) for surface flattening. It should be noted that the recording layer 14 may sometimes deteriorate in quality in the vicinity of the upper surface due to such factors as the process for dividing the recording layer 14 into the concavo-convex pattern and the process for removing the mask layers. In such cases, the etching may be continued even after the filler underlayer film 18 and the separating film 22 over the recording elements 14A are removed, so that the deteriorated portions of the recording elements 14A near the upper surface are removed.

Next, the protective layer 28 is formed over the recording elements 14A and the filler 20 by CVD (S118). The lubricating layer 30 is also applied onto the protective layer 28 by dipping (S120). This completes the magnetic recording medium 10 shown in FIGS. 2 and 3 seen above.

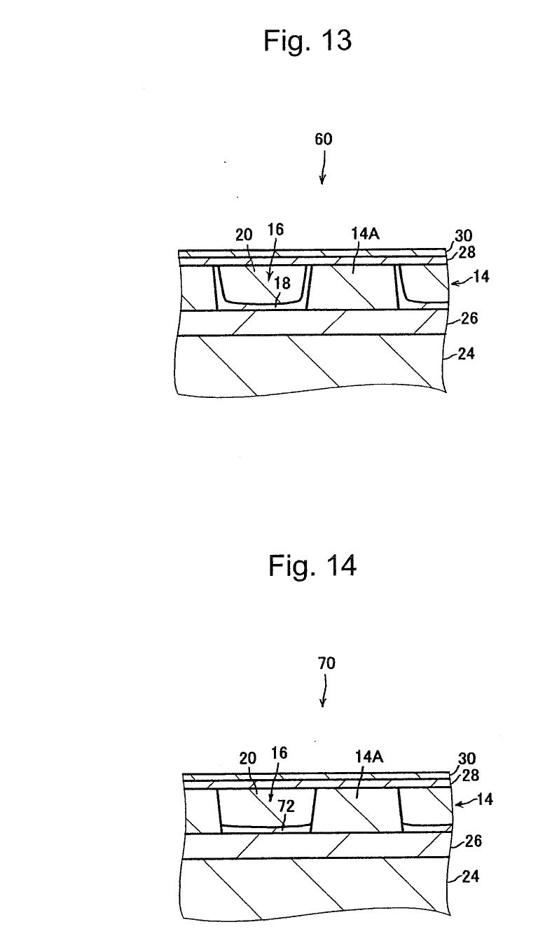

A description will now be given of a second exemplary embodiment of the present invention. In the magnetic recording medium 10 according to the foregoing first exemplary embodiment, the separating film 22 containing neither Si nor Ge is arranged between the recording layer 14 and the filler underlayer film 18 so as to separate these from each other. In contrast, as shown in FIG. 13, a magnetic recording medium 60 according to the second exemplary embodiment includes no separating film 22, and the recording layer 14 and the filler underlayer film 18 are in contact with each other. In other respects, the configuration is the same as that of the magnetic recording medium 10 according to the foregoing first exemplary embodiment. The same components will thus be designated by like reference numerals in FIGS. 1 to 12, and a description will be omitted.

Suppose that the filler underlayer film 18 contains neither Si nor Ge, and/or that the recording layer 14 does not contain Co. In these cases, the separating film 22 can be thus omitted to put the recording layer 14 and the filler underlayer film 18 into contact without the problem that Si or Ge contained in the filler underlayer film 18 will change the magnetic characteristics of the recording layer 14. Suppose also that the filler underlayer film 18 contains Si or Ge and the recording layer 14 contains Co. Even in this case, the separating film 22 may be thus omitted if the Si or Ge contained in the filler underlayer film 18 produces as small change in the magnetic characteristics of the recording layer 14 as substantially negligible. Note that the magnetic recording medium 60 may be manufactured by the same manufacturing method as that of the magnetic recording medium 10 but the separating film deposition step (S108) is omitted.

A description will now be given of a third exemplary embodiment of the present invention. In the magnetic recording medium 10 according to the foregoing first exemplary embodiment, the filler underlayer film 18 is formed all over the bottoms and sides of the concave portioned 16. In contrast, as shown in FIG. 14, a magnetic recording medium 70 according to the third exemplary embodiment has a filter underlayer film 72 which is not formed on all the sides of the concave portions 16. The magnetic recording medium 70 does not have the separating film 22, either. In other respects, the configuration is the same as that of the magnetic recording medium 10 according to the foregoing first exemplary embodiment. The same components will thus be designated by like reference numerals in FIGS. 1 to 12, and a description will be omitted.

As above, even if the filler underlayer film 72 is not formed on all the sides of the concave portions 16, the DLC filler 20 is formed in contact with the filler underlayer film 72 on the bottoms of the concave portions 16. The firm adhesion to the filler underlayer film 72 on the bottoms of the concave portions 16 provides the effect of suppressing exfoliation of the filler 20.

Suppose that the filler underlayer film 72 and the recording layer 14 make contact only in the narrow areas near the bottoms of the concave portions 16, not in the other areas. In this case, Si or Ge contained in the filler underlayer film 72 and Co contained in the recording layer 14, if any, are hard to chemically combine with each other. This suppresses the change in the magnetic characteristics of the recording layer 14 resulting from the Si or Ge contained in the filler underlayer film 72 to as small as substantially negligible. If the filler underlayer film 72 is formed on major portions of the sides of the concave portions 16, on the other hand, a separating film is preferably formed like the separating film 22 of the foregoing first exemplary embodiment.

The magnetic recording medium 70 may be manufactured by the manufacturing method of the magnetic recording medium 10, wherein the filler underlayer film deposition step (S110) employs a deposition technique in which deposition particles travel with a high straightness, such as ion beam deposition (IBD). The surface of the object to be processed is thus irradiated with the particles generally perpendicularly to deposit the filler underlayer film 72.

Now, the foregoing first exemplary embodiment has dealt with the case where a mixed gas of O₂ gas and Ar gas is used in the former flattening step (S114). The types of gases to be used in the former flattening step (S114) are not limited in particular, however, as long as the etching conditions can be set so that the etching rate to the filler 20 is higher than those to the filler underlayer film 18 and the separating film 22. For example, O₂ gas alone may be used as the process gas. Hydrogen-containing gases such as H₂ gas and NH₃ gas may also be used. The same applies to the foregoing second and third exemplary embodiments.

In the first exemplary embodiment, Ar gas is used in the latter flattening step (S116). The type of gas to be used in the latter flattening step (S116) is not particularly limited, either, as long as the etching conditions can be set so that the etching rates to the filler underlayer film 18 and the separating film 22 are higher than that to the filler 20. For example, Kr, Xe, or other rare gases may be used. The same applies to the second and third exemplary embodiments.

In the first exemplary embodiment, an excess of the filler underlayer film 18 and the separating film 22 above the recording elements 14A is removed in the latter flattening step (S116). Nevertheless, the excess of the filler underlayer film 18 above the recording elements 14A may be completely removed in the former flattening step (S114). In this case, the etching conditions in the latter flattening step (S116) are preferably set so that the etching rate to the separating film 22 is higher than that to the filler 20. When the etching rate to the separating film 22 is higher than that to the filler 20, the separating film 22 over the recording elements 14A is etched faster than the filler 20 in the concave portions 16. This reduces the difference in level between the concave portions and the convex portions.

The first exemplary embodiment has dealt with the case where the directions of incidence of the process gases are perpendicular to the surface of the object to be processed 40 in the former flattening step (S114) and the latter flattening step (S116). The surface of the object to be processed 40, however, may be irradiated with the process gases with a direction of incidence oblique to the surface of the object to be processed 40. The same applies to the second and third exemplary embodiments.

The first exemplary embodiment has dealt with the case where the etching in the former flattening step (S114) is stopped based on the result of detection of components contained in the filler underlayer film 18 or the separating film 22 that is removed with the filler 20. Nevertheless, the etching may be stopped, for example, based on a lapse of predetermined process time. The same applies to the second and third exemplary embodiments.

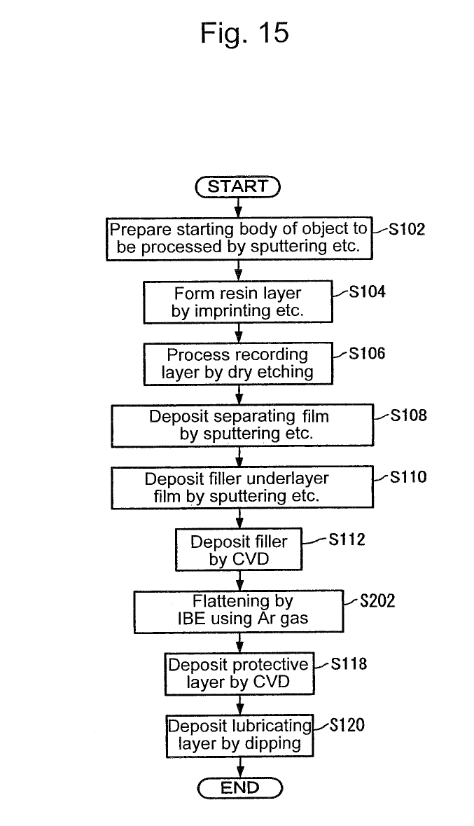

In the first exemplary embodiment, the excesses of the filler underlayer film 18, the separating film 22, and the filler 20 above the recording elements 14A are removed and flattened through the two flattening steps (including the former flattening step (S114) and the latter flattening step (S116)). As in a fourth exemplary embodiment of the present invention which is shown in the flowchart of FIG. 15, however, the excesses of the filler underlayer film 18, the separating film 22, and the filler 20 above the recording element 14A may be removed and flattened by a single flattening step (S202). In this instance, as in the latter flattening step (S116), the etching conditions in the flattening step (S202) are preferably set so that the etching rates to the filler underlayer film 18 and the separating film 22 are higher than that to the filler 20. Assuming that the filler 20 is deposited directly on the recording elements 14A and then an excess of the filler 20 is etched for flattening, it would be difficult to reduce the difference in level between the concave portions and the convex portions at the surface sufficiently. On the other hand, the separating film 22, the filler underlayer film 18, and the filler 20 are deposited over the recording elements 14A before the excesses of the filler 20, the filler underlayer film 18, and the separating film 22 are etched for flattening. When the etching rates to the filler underlayer film 18 and the separating film 22 are set to be higher than that to the filler 20, the filler underlayer film 18 and the separating film 22 over the recording elements 14A can be etched faster so that the difference in level between the surfaces of the concave portions and the convex portions is reduced sufficiently for the improved flatness.

In the first exemplary embodiment, the first mask layer 42, the second mask layer 44, and the resin layer 46 are formed over the continuous film of the recording layer 14 before the recording layer 14 is divided into the concavo-convex pattern through three steps of dry etching. Nevertheless, the materials of the mask layers and the resin layer, the number of layers to be stacked, the thicknesses of the layers, and the types of dry etching are not limited in particular as long as the recording layer 14 can be divided with high precision. The same applies to the foregoing second to fourth exemplary embodiments.

In the first exemplary embodiment, the soft magnetic layer 24 and the seed layer 26 are formed under the recording layer 14. The configuration of the layers under the recording layer 14 may be modified as appropriate, however, depending on the type of the magnetic recording medium. For example, an underlayer or an antiferromagnetic layer may be formed between the soft magnetic layer 24 and the substrate 12. Either one or both of the soft magnetic layer 24 and the seed layer 26 may be omitted. A recording layer may be formed directly on the substrate. The same applies to the second to fourth exemplary embodiments.

In the first to third exemplary embodiments, the magnetic recording media 10, 60 and 70 are discrete track media of perpendicular recording type in which the recording layer 14 is divided at small intervals in the radial direction of the tracks. It will be understood, however, that the present invention is also applicable to the following: a patterned medium having recording layer divided at small intervals both in the radial direction and the circumferential direction of the tracks; a magnetic disk having a recording layer of spiral configuration; a magnetic disk having a recording layer that is formed on the upper surfaces of convex portions and the bottoms of concave portions of a concavo-convex patterned underlayer separately so that the portions formed on the upper surfaces of the convex portions constitute recording elements; a magnetic disk having a concavo-convex patterned recording layer that is continuous at the bottom, having concave portions halfway in the thickness direction; and a magnetic disk having a concavo-convex patterned recording layer of a continuous film which is deposited in the concavo-convex pattern following a concavo-convex patterned underlayer. In addition, the present invention is also applicable to magneto optical disks such as MOs, thermally assisted magnetic disks for which magnetism and heat are used in combination, and magnetic tapes and other magnetic recording media of non-disk configuration that have a recording layer formed in a concavo-convex pattern. The same applies to the fourth exemplary embodiment.

### Working Example 1

A magnetic recording medium 10 was fabricated according to the foregoing first exemplary embodiment. Specifically, the recording layer 14 was initially processed into the following concavo-convex pattern (S106).

Radial pitch of the recording elements 14A: 200 nm

Radial width of the upper surfaces of the recording elements 14A: 100 nm

Depth of the concave portion: 24 nm

The recording layer 14 had a thickness of 20 nm. The recording layer 14 was made of a CoCr alloy.

Next, the separating film 22 was deposited by sputtering over the object to be processed 40 on which the recording layer 14 with the concavo-convex pattern was exposed, under the deposition conditions below (S108). The separating film 22 was deposited in a concavo-convex pattern following the concavo-convex pattern of the recording layer 14.

Material of the separating film 22: Ta

Deposition thickness of the separating film 22: 2 nm

Source power (electric power applied to the target): 500 W

Chamber pressure: 0.3 Pa

Distance between the target and the object to be processed 40: 300 mm

Using the same deposition system, the filler underlayer film 18 was then deposited on the separating film 22 by sputtering under the deposition conditions below (S110). The filler underlayer film 18 was also deposited in a concavo-convex pattern following the concavo-convex pattern of the recording layer 14.

Material of the filler underlayer film 18: Si

Deposition thickness of the filler underlayer film 18: 2 nm

Source power (electric power applied to the target): 500 W

Chamber pressure: 0.3 Pa

Distance between the target and the object to be processed 40: 300 mm

Next, the filler 20 was deposited on the filler underlayer film 18 by using ECR plasma CVD under the deposition conditions below, whereby the concave portions 16 were filled with the filler 20 (S112). Though the filler 20 was also deposited in a concavo-convex pattern following the concavo-convex pattern of the recording layer 14, the difference in level between the concave portions and the convex portions of the filler 20 was smaller than that of the recording layer 14.

Material of the filler 20: DLC

Deposition thickness of the filler 20: 221 nm

Material gas: methane

Flow rate of the material gas: 200 sccm

Chamber pressure: 1.33 Pa

Microwave power: 200 W

RF power: 300 W

Vdc (effective DC voltage applied to the object to be processed): −460 V

The duration of the deposition was 23 min 28 sec. The difference in level between the concave portions and the convex portions at the upper surface of the filler 20 was 4 nm.

Next, an excess of the filler 20 above the recording elements 14A was removed by IBE using a mixed gas of O₂ gas and Ar gas as the process gas, under the conditions below (S114). Here, Si (filler underlayer film 18) was detected by SIMS during etching, and the etching was stopped immediately after the amount of Si detected reached a local maximum value.

Flow rate of O₂ gas: 50 sccm

Flow rate of Ar gas: 3 sccm

Chamber pressure: 0.08 Pa

Angle of incidence of the process gas: 90°

Beam voltage: 500 V

Beam current: 400 mA

Suppressor voltage: 400 V

The duration of the etching was 2 min 39 sec. This etching condition provided an etching rate of 1.26 nm/sec to the DLC filler 20.

Next, excesses of the filler underlayer film 18 and the separating film 22 above the recording elements 14A were removed by IBE using Ar gas as the process gas, under the conditions below (S116). The etching was stopped after 11 sec. The excesses of the filler underlayer film 18 and the separating film 22 above the recording elements 14A were removed completely.

Flow rate of Ar gas: 16 sccm

Chamber pressure: 0.05 Pa

Angle of incidence of the process gas: 90°

Beam voltage: 500 V

Beam current: 500 mA

Suppressor voltage: 400 V

These conditions provided the following etching rates to the filler 20, the filler underlayer film 18, and the separating film 22, respectively.

Filler 20 (DLC): 0.08 nm/sec

Filler underlayer film 18 (Si): 0.40 nm/sec

Separating film 22 (Ta): 0.35 nm/sec

At this point, adhesive tapes were attached to the surface of the object to be processed 40, and then removed from the surface of the object to be processed 40 to observe the surface of the object to be processed 40. The following two types of adhesive tapes were used:

Scotchpro (registered trademark) 375, No. 375 (from Sumitomo 3M Limited), adhesive power: 5.88 N/cm, and

Laminated cloth tape YR-3738 (from Sumitomo 3M Limited), adhesive power: 2.74 N/cm.

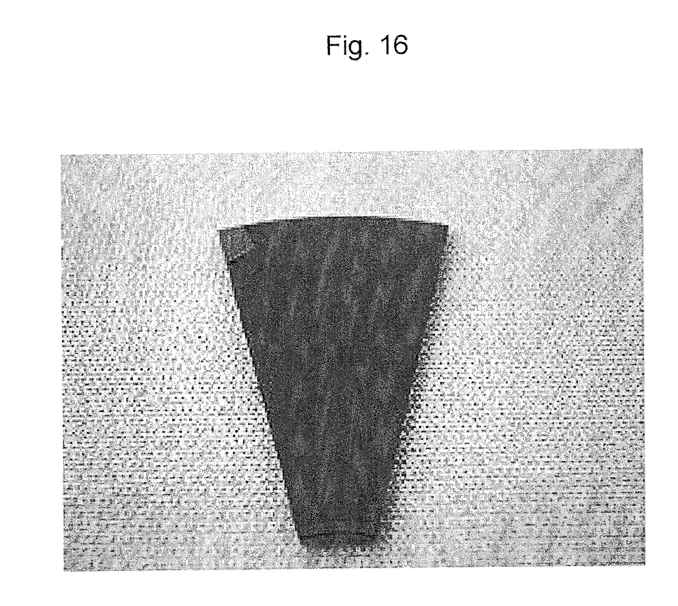

No defects such as exfoliation of the filler 20 were observed in both cases of the adhesive tapes. FIG. 16 is a photograph showing the surface of the object to be processed 40 to which the foregoing two types of adhesive tapes have been attached immediately after the completion of the latter flattening step (S116), followed by the removal of these adhesive tapes from the surface of the object to be processed 40. In FIG. 16, the pale area on the upper left of the sample is where the filler 20 had not been deposited from the beginning not indicating exfoliation of the filler 20.

After a lapse of 24 hours since the completion of the latter flattening step (S116), the two types of adhesive tapes were attached to the surface of the object to be processed 40 again. These adhesive tapes were then removed from the surface of the object to be processed 40 to observe the surface of the object to be processed 40. Again, no defects such as exfoliation of the filler 20 were observed.

### Working Example 2

A magnetic recording medium 60 was fabricated according to the foregoing second exemplary embodiment. Specifically, the working example 1 was modified to omit the deposition of the separating film 22. The rest of the conditions were the same as in the working example 1.

As in the working example 1, the foregoing two types of adhesive tapes were attached to the surface of the object to be processed 40 when the latter flattening step (S116) was completed, and after a lapse of 24 hours since the completion of the latter flattening step (S116). The adhesive tapes were then removed from the surface of the object to be processed 40 to observe the surface of the object to be processed 40. In either case, no defects such as exfoliation of the filler 20 were observed.

### Comparative Example 1

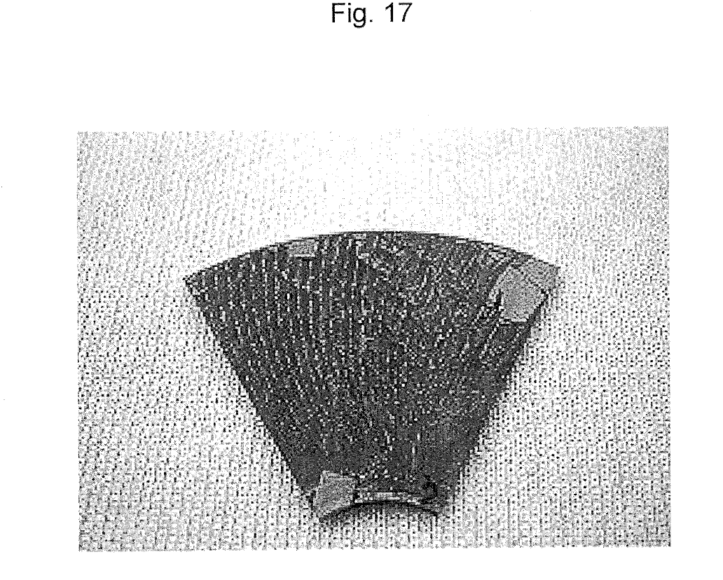

In contrast to the foregoing working example 1, the deposition of the separating film 22 and the deposition of the filler underlayer film 18 were omitted. The rest of the conditions were the same as in the working example 1. The deposition of the filler 20 over the recording layer 14 was attempted to the same thickness of 221 nm as in the working example 1. The filler 20 exfoliated from the object to be processed 40, however, so that the DLC filler 20 could not be deposited as in the working example 1. FIG. 17 is a photograph showing the surface of the object to be processed 40 immediately after the filler deposition step (S112) was attempted. In FIG. 17, the pale areas on the lower left and the upper right of the sample are where the filler 20 had not been deposited from the beginning, not indicating exfoliation of the filler 20.

### Comparative Example 2

Like the foregoing comparative example 1, the deposition of the separating film 22 and the deposition of the filler underlayer film 18 were omitted in contrast to the working example 1. The filler 20 was deposited over the recording layer 14 to a thickness of 161 nm, smaller than in the working example 1. The rest of the conditions were the same as in the working example 1. The filler 20 was deposited over the object to be processed 40 successfully without exfoliation. The difference in level between the concave portions and convex portions at the upper surface of the deposited filler 20 was 7 nm, greater than in the working example 1.

As in the working example 1, the former flattening step (S114) and the latter flattening step (S116) were performed. After the completion of the latter flattening step (S116), the surface of the object to be processed 40 was observed to find out that the filler 20 exfoliated in part.

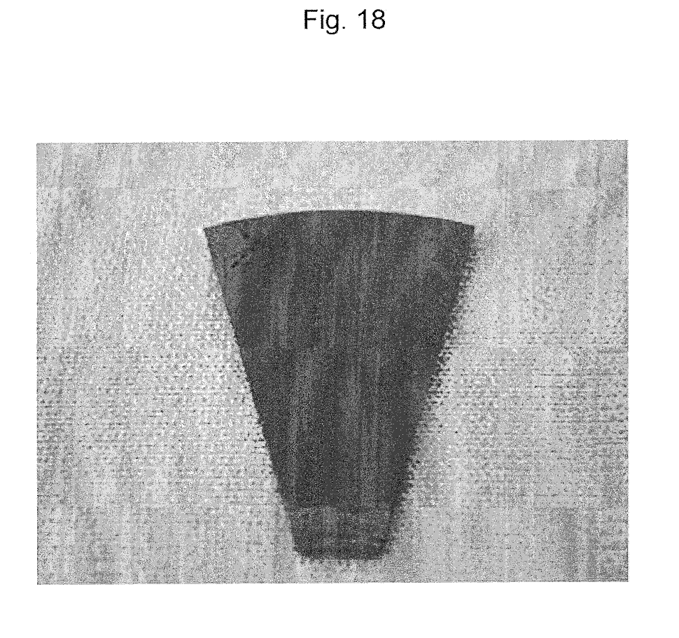

As in the working example 1, the two types of adhesive tapes were also attached to the surface of the object to be processed 40 when the latter flattening step (S116) was completed, and after a lapse of 24 hours since the completion of the latter flattening step (S116). The adhesive tapes were then removed from the surface of the object to be processed 40 to observe the surface of the object to be processed 40. In either case, some of the filler 20 adhered to the adhesive tapes and exfoliated from the object to be processed 40. FIG. 18 is a photograph showing the surface of the object to be processed 40 to which the adhesive tape of smaller adhesive power (laminated cloth tape YR-3738) has been attached immediately after the completion of the latter flattening step (S116), followed by the removal of this adhesive tape from the surface of the object to be processed 40. In FIG. 18, the pale area on the upper left of the sample is where the filler 20 had not been deposited from the beginning, not indicating the exfoliation of the filler 20.

As above, the filler exfoliated in the comparative examples 1 and 2 where the DLC filler was deposited without the deposition of the filler underlayer film. In contrast, the filler caused no exfoliation in the working examples 1 and 2 where the filler was deposited in contact with the filler underlayer film after the filler underlayer film was deposited. In other words, it was confirmed that the exfoliation of the filler can be avoided by depositing the filler in contact with the filler underlayer film after the filler underlayer film was deposited.

What is claimed is:

1. A magnetic recording medium comprising:
a substrate;
a recording layer formed over the substrate in a predetermined concavo-convex pattern, a convex portion of the concavo-convex pattern constituting a recording element;
a filler underlayer film formed on a bottom of a concave portion of the concavo-convex pattern; and
a DLC filler formed on the filler underlayer film in contact with the filler underlayer film so as to fill the concave portion,
the filler underlayer film being made of a material selected from the group consisting of a Si-containing material, a Ge-containing material, and a carbide material containing one or more metal elements selected from Ti, Ta, Nb, Mo, Zr, Cr, W, V, and Hf.

2. The magnetic recording medium according to claim 1, wherein the filler underlayer film is also formed on a side of the concave portion, and the filler is also in contact with the filler underlayer film on the side of the concave portion.

3. The magnetic recording medium according to claim 1, wherein: the filler underlayer film is made of any of a Si-containing material and a Ge-containing material; and a separating film containing neither Si nor Ge is formed between the recording layer and the filler underlayer film so as to separate them from each other.

4. The magnetic recording medium according to claim 2, wherein: the filler underlayer film is made of any of a Si-containing material and a Ge-containing material; and a separating film containing neither Si nor Ge is formed between the recording layer and the filler underlayer film so as to separate them from each other.

5. The magnetic recording medium according to claim 1, further comprising a protective layer formed on the recording layer, an upper surface of the recording layer being in contact with the protective layer.

6. The magnetic recording medium according to claim 2, further comprising a protective layer formed on the recording layer, an upper surface of the recording layer being in contact with the protective layer.

7. The magnetic recording medium according to claim 3, further comprising a protective layer formed on the recording layer, an upper surface of the recording layer being in contact with the protective layer.

8. A magnetic recording and reproducing apparatus comprising:
the magnetic recording medium according to claim 1; and
a magnetic head.

9. A magnetic recording and reproducing apparatus comprising:
the magnetic recording medium according to claim 2; and
a magnetic head.

10. A magnetic recording and reproducing apparatus comprising:
the magnetic recording medium according to claim 3; and
a magnetic head.

11. A method for manufacturing a magnetic recording medium, comprising:
a filler underlayer film deposition step of depositing a filler underlayer film on at least a bottom of a concave portion and an upper surface of a convex portion of a predetermined concavo-convex pattern on an object to be processed, the object to be processed having a substrate and a recording layer formed over the substrate in the concavo-convex pattern, the convex portion of the concavo-convex pattern constituting a recording element;
a filler deposition step of depositing a DLC filler over the object to be processed so as to be in contact with the filler underlayer film, thereby filling the concave portion of the concavo-convex pattern with the filler; and
a flattening step of etching an excess of the filler above the recording element to flatten the surface,
the filler underlayer film being made of a material selected from the group consisting of a Si-containing material, a Ge-containing material, and a carbide material containing one or more metal elements selected from Ti, Ta, Nb, Mo, Zr, Cr, W, V, and Hf.

12. The method for manufacturing a magnetic recording medium according to claim 11, further comprising a separating film deposition step of depositing a separating film containing neither Si nor Ge over the object to be processed following the concavo-convex pattern prior to the filler underlayer film deposition step, and wherein
a Si-containing film or a Ge-containing film is deposited as the filler underlayer film in the filler underlayer film deposition step while the separating film separates the recording layer from the filler underlayer film.

13. The method for manufacturing a magnetic recording medium according to claim 11, wherein the etching is stopped in the flattening step based on a result of detection of a component contained in the filler underlayer film which is removed with the filler.

14. The method for manufacturing a magnetic recording medium according to claim 13, wherein the etching is stopped in the flattening step based on detecting a local maximum value of a detected amount of the component contained in the filler underlayer film.

15. The method for manufacturing a magnetic recording medium according to claim 11, wherein an etching condition in the flattening step is set so that an etching rate to the filler underlayer film is higher than that to the filler.

16. The method of manufacturing a magnetic recording medium according to claim 11, wherein
the flattening step includes:
a former flattening step in which an etching condition is set so that an etching rate to the filler is higher than that to the filler underlayer film; and
a latter flattening step in which an etching condition is set so that an etching rate to the filler underlayer film is higher than that to the filler.

17. The method of manufacturing a magnetic recording medium according to claim 12, wherein
the flattening step includes:
a former flattening step in which an etching condition is set so that an etching rate to the filler is higher than that to the filler underlayer film; and
a latter flattening step in which an etching condition is set so that an etching rate to the separating film is higher than that to the filler.
